(19) United States
(12) Patent Application Publication
(10) Pub. No.: US 2008/0196491 A1
(43) Pub. Date: Aug. 21, 2008

(54) INTEGRATED PRESSURE SENSOR WITH A HIGH FULL-SCALE VALUE

(75) Inventors: Giulio Ricotti, Broni (IT); Marco Morelli, Bareggio (IT); Luigi Della Torre, Lissone (IT); Andrea Lorenzo Vitali, Bergamo (IT)

Correspondence Address: SEED INTELLECTUAL PROPERTY LAW GROUP PLLC, 701 FIFTH AVENUE, SUITE 5400, SEATTLE, WA, 98104-7092, US

(73) Assignee: STMICROELECTRONICS S.R.L., Agrate Brianza (IT)

(21) Appl. No.: 12/018,054

(22) Filed: Jan. 22, 2008

Related U.S. Application Data
(63) Continuation-in-part of application No. PCT/IT2005/000435, filed on Jul. 22, 2005.

(51) Int. Cl. G01L 9/06; G01L 5/28

(52) U.S. Cl. 73/132; 73/727

(57) ABSTRACT

In an integrated pressure sensor with a high full-scale value, a monolithic body of semiconductor material has a first and a second main surface, opposite and separated by a substantially uniform distance. The monolithic body has a bulk region, having a sensitive portion next to the first main surface, upon which pressure acts. A first piezoresistive detection element is integrated in the sensitive portion and has a variable resistance as a function of the pressure. The bulk region is a solid and compact region and has a thickness substantially equal to the distance.

### CROSS-REFERENCE TO RELATED APPLICATION

This application is a continuation-in-part of International Patent Application No. PCT/IT2005/000435, filed Jul. 22, 2005, now pending, which application is incorporated herein by reference in its entirety.

### BACKGROUND

1. Technical Field

This invention relates to an integrated pressure sensor made using semiconductor technologies, which has a high full-scale value and therefore allows the measurement of high pressures. In particular, the following description makes specific reference, without this implying any loss of generality, to the use of this pressure sensor in a BBW (Brake-By-Wire) electromechanical braking system.

2. Description of the Related Art

As is known, traditional disc braking systems for vehicles include a disc that is fixed to a respective wheel of the vehicle, a caliper associated with the disc and a hydraulic control circuit. Pads (normally two in number) made of a friction material and one or more pistons connected to the hydraulic control circuit are housed inside the caliper. Following the operation of the brake pedal by a user, a pump in the hydraulic control circuit pressurizes a fluid contained within the circuit. Consequently, the pistons, equipped with sealing elements, leave their respective seats and press the pads against the surface of the disc, thereby exerting a braking action on the wheel.

Recently, so-called “Drive-by-Wire” systems have been proposed, which provide for the electronic control of a vehicle's main functions, such as for example the steering system, the clutch and the braking system. In particular, electronically controlled braking systems have been proposed that envisage the substitution of hydraulic calipers with electromechanical actuators. In detail, suitable sensors detect the operation of the brake pedal and generate corresponding electrical signals that are then received and interpreted by an electronic control unit. The electronic control unit then controls the operation of the electromechanical actuators (for example, pistons driven by an electric motor), which exert the braking action on the brake discs via the pads. The electronic control unit also receives information from the sensors associated with the braking system regarding the braking action exerted by the electromechanical actuators, in order to accomplish a closed-loop feedback control (for example, via a proportional-integral-derivative controller—PID). In particular, the electronic control unit receives information on the pressure exerted by each actuator on the respective brake disc.

Pressure sensors with a high full-scale value are needed for measuring this pressure. In fact, the force with which the pads are pressed against the disc can have values from 0 up to a maximum in the range 15,000 N-35,000 N. The piston acting on the pads has a section of approximately 2 cm² and hence the pressure sensors must be capable of working up to full-scale values of around 1700 Kg/cm² or higher.

At present, sensors capable of measuring such high pressure values are made with a steel core on which strain gauge elements are fixed. Under the effect of pressure, the steel core deforms according to Hook's Law:

ΔL=E·σ

where ΔL indicates the geometric variation of a linear dimension of the core, E is Young's Module of the material constituting the core and σ is the pressure acting on the core in a direction parallel to the deformation dimension. The strain gauge elements detect the geometric deformation of the core to which they are associated via changes in electrical resistance.

However, for reasons of reliability, dimensions and costs, these sensors are only applicable to and utilizable for the purposes of characterization and development of a braking system of the previously described type, not the production phase.

Integrated pressure sensors, made using semiconductor technology, are also known. These sensors include a thin membrane suspended above a cavity made in a monocrystalline silicon body. Piezoresistive elements connected to each other to form a Wheatstone bridge are diffused inside the membrane. When subjected to pressure, the membrane deforms, causing a change in resistance of the piezoresistive elements, and therefore the unbalancing of the Wheatstone bridge. In particular, in order to form a balanced Wheatstone bridge, some piezoresistive elements are normally subjected to compression stress, while the remainder are subjected to tension stress.

However, with a high pressure, the membrane undergoes such a deformation in the vertical direction that it contacts the bottom of the underlying cavity, in this way saturating the pressure value provided at output. Typically, this saturation takes place at significantly lower pressures than the pressure values that occur in the previously described braking systems (in particular, for pressures of around 10 Kg/cm²). Consequently, these pressure sensors are not exploitable for the measurement of high pressures.

### BRIEF SUMMARY

One embodiment provides an integrated pressure sensor having a high full-scale value and allowing the above-mentioned drawbacks and problems to be overcome.

According to one embodiment, an integrated pressure sensor, as defined in claim 1, is therefore provided.

### BRIEF DESCRIPTION OF THE SEVERAL VIEWS OF THE DRAWINGS

For a better understanding of the invention, preferred embodiments will now be described, purely by way of non-limitative example and with reference to the attached drawings, wherein:

FIG. 1 illustrates a block diagram of an electromechanical Brake-By-Wire braking system,

FIG. 2 shows a perspective section of an integrated pressure sensor made according to a first embodiment of the present invention,

FIG. 3 shows a cross-section of a pressure sensor in a second embodiment of the present invention,

FIG. 4 is an equivalent circuit diagram of the pressure sensor in FIG. 3,

FIG. 5 shows a schematic top view of a pressure sensor made in accordance with the second embodiment, and

FIG. 6 shows a pressure-measuring device according to one embodiment.

### DETAILED DESCRIPTION

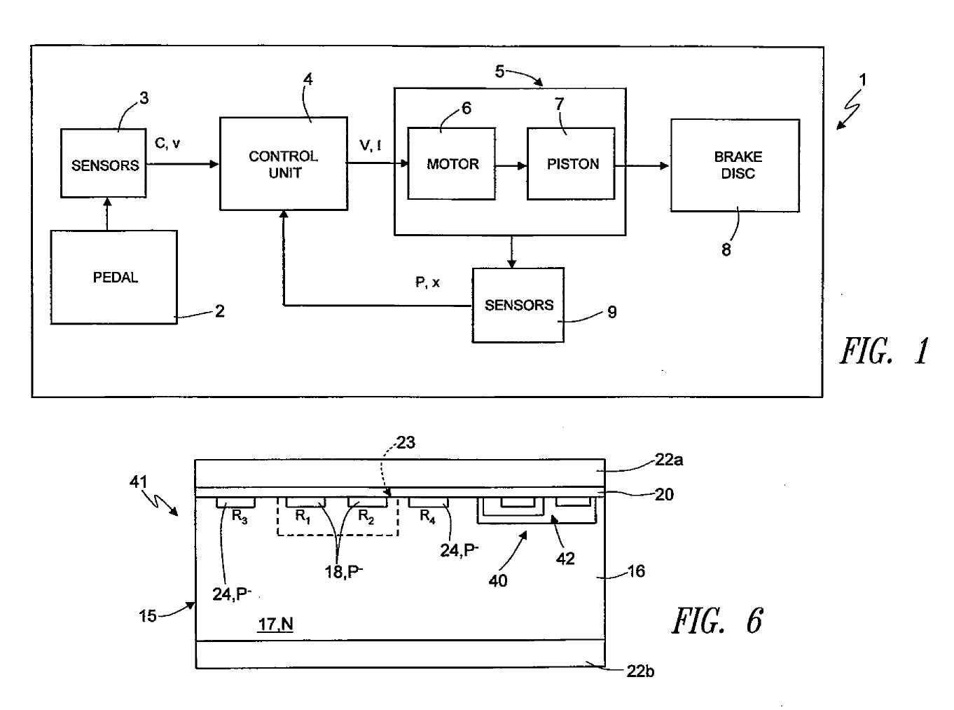

FIG. 1 shows a block diagram of a braking system 1 of the Brake-By-Wire electromechanical type, comprising: a brake pedal 2, first sensors 3 suitable for detecting the travel C and actuation speed v of the brake pedal 2, an electronic control unit 4 connected to the first sensors 3, an electromechanical actuator 5 connected to the electronic control unit 4 and consisting of an electric motor 6 and a piston 7 connected to the electric motor 6 via a worm screw type connection element (non illustrated), a brake disc 8 connected to the electromechanical actuator 5 and fixed to a wheel of the vehicle (in a per se known manner which is not shown), and second sensors 9 suitable for collecting information regarding the braking action exerted by the electromechanical actuator 5 on the brake disc 8 and connected in feedback to the electronic control unit 4.

In use, the first sensors 3 send data regarding the travel C and actuation speed v of the brake pedal 2 to the electronic control unit 4, which, based on this data, generates a control signal (a voltage V, or current I signal) for the electromechanical actuator 5 (in particular, for the electric motor 6). As a function of this control signal, the electric motor 6 generates a drive torque that is transformed into a linear movement of the piston 7 by the worm screw type connection element. As a consequence, the piston 7 presses on the brake disc 8 (via pads of abrasive material, not shown), so as to slow down its rotation. The second sensors 9 detect the pressure value P exerted by the piston 7 on the brake disc 8 and the position x of the piston 7 with respect to the brake disc 8, and send this data in feedback to the electronic control unit 4. In this way, the electronic control unit 4 exercises a closed-loop control (a PID control, for example) on the braking action.

According to one embodiment, the second sensors 9 comprise an integrated pressure sensor 15 (FIG. 2), made using semiconductor technology, and suitable for measuring the pressure P exerted by the piston 7 on the brake disc 8. As it is not shown, the pressure sensor 15 is housed in a casing of the electromechanical actuator 5 and is configured to be sensitive to the pressure P exerted by the piston 7.

In detail, the pressure sensor 15 comprises a monolithic body 16 of semiconductor material, preferably N-type monocrystal silicon with orientation (100) of the crystallographic plane. The monolithic body 16 has a square section, with sides 1 equal to 800 μm for example, a first main external surface 16a, whereon the pressure P acts, and a second main external surface 16b, separated from the first main external surface 16a by a substantially uniform distance w, equal to 400 μm for example. In particular, the first and the second main external surfaces 16a and 16b are opposite and parallel.

The monolithic body 16 comprises a bulk region 17, and inside a portion of the bulk region 17, next to the first main external surface 16a, piezoresistive detection elements 18 are formed, constituted by doped P⁻-type regions (by way of example, four piezoresistive detection elements 18 are shown in FIG. 2). In particular, the piezoresistive detection elements 18 are formed via diffusion of dopants through an appropriate diffusion mask, and have, for example, an approximately rectangular section. As described in the following, the resistance of the piezoresistive detection elements 18 varies as a function of the pressure P acting on the monolithic body 16. In particular, the bulk region 17 of the monolithic body 16 is a solid and compact region, having a thickness that is substantially constant and equal to the distance w.

A passivation layer 20 (of silicon monoxide for example) covers the first main external surface 16a of the monolithic body 16, and a first and a second cushion layer 22a and 22b, composed of an elastic material, polyamide for example, are formed on top of the passivation layer 20, and below the second main external surface 16b of the monolithic body 16.

The operation of the pressure sensor 15 is based on the so-called piezoresistive effect, according to which a stress applied to a piezoresistive element causes a change in its resistance. In the case of semiconductor materials, such as silicon, the applied stress causes a deformation of the crystal lattice and thus an alteration in the mobility of the majority charge carriers. For example, in the case of silicon, a 1% deformation of the crystal lattice corresponds to a change of approximately 30% in the mobility of the majority charge carriers. This gives rise to a change in resistance of the resistance elements formed in the semiconductor material. This change in resistance is caused by stress acting in both the parallel direction (so-called longitudinal stress) and in the normal direction (so-called transversal stress) to the plane in which the resistance elements lie. In particular, one embodiment exploits the piezoresistive effect that arises in a solid and compact block of monocrystal silicon when stress is applied in a normal direction to one of its main external surfaces.

In detail, the change in resistance of a piezoresistive element can usually be expressed by the following relation:

$$\frac{Δ R}{R} = \frac{{Π}_{44}}{2} ( {σ}_{1} - {σ}_{t} )$$

where R is the resistance of the piezoresistive element, Π₄₄ is the piezoresistive coefficient of the semiconductor material, equal to 138.1.10⁻¹¹ Pa⁻¹ for P-type monocrystal silicon for example, and σ₁ and σₜ are the respective longitudinal and transversal stresses acting on the piezoresistive element.

With reference to the pressure sensor 15 in FIG. 2, the monolithic body 16 is arranged in a such a way that the pressure P to be measured causes stress in a direction normal to the first main external surface 16a. A transversal compression stress σₜ (of a negative value) coincident with the pressure P and a substantially null longitudinal stress σ₁ (in the hypothesis that flexure or curving phenomena do not occur in the monolithic body 16) therefore act on each piezoresistive detection element 18. In particular, the first cushion layer 22a uniformly distributes the compression stress on the first main external surface 16a of the monolithic body 16, avoiding local focusing that could cause cracks along the axes of the crystal lattice. The change in resistance of the piezoresistive detection elements 18 is therefore expressed by the relation:

$$\frac{Δ R}{R} = - \frac{{Π}_{44}}{2} \cdot {σ}_{t}$$

from which it follows that the pressure P causes an increase in the resistance R of each piezoresistive detection element 18, which can be measured by a suitable measuring circuit, in order to determine the value of the pressure P.

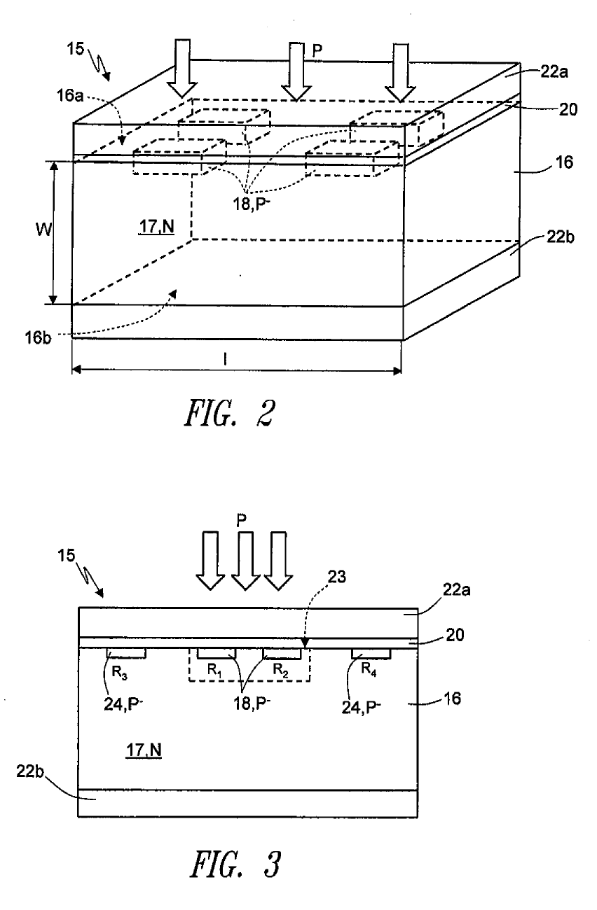

According to one embodiment, FIG. 3, the bulk region 17 of the monolithic body 16 has a pressure-sensitive portion 23 next to the first main external surface 16a, arranged, for example, in a central position with respect to the body (indicated in FIG. 3 by the dashed rectangle), upon which the pressure P to be measured is applied. The pressure acting outside of the pressure-sensitive portion 23, instead, is essentially null.

The piezoresistive detection elements 18 are formed inside the pressure-sensitive portion 23, while reference elements 24, also constituted of diffused P⁻-type piezoresistances, are formed in a portion of the bulk region 17, distinct and separate from the pressure-sensitive portion 23. In this way, the reference elements 24 do not exhibit changes in resistance as a function of the pressure P.

In detail, FIG. 3 shows two piezoresistive detection elements 18, R₁ and R₂, and two reference elements 24, R₃ and R₄. The reference elements 24 are connected to the piezoresistive detection elements 18 so as to form a Wheatstone-bridge circuit 25 (FIG. 4), in which the variable resistances R₁ and R₂ are placed on opposite sides of the bridge, in order to increase the sensitivity.

In use, the Wheatstone-bridge circuit 25 is fed with a supply voltage Vᵢₙ and supplies an output voltage Vₒᵤₜ. The pressure P acting on the pressure-sensitive portion 23 causes a change (equal and in the same sense) as the resistances of the piezoresistive detection elements 18, while the resistances of the reference elements 24 remain constant. Unbalancing of the Wheatstone-bridge circuit 25 therefore occurs, giving a non-zero output voltage Vₒᵤₜ. A suitable electronic measurement circuit (including at least one instrumentation amplifier) can then measure the pressure P from that output voltage Vₒᵤₜ.

In particular, the reference elements 24 are subject to the same environmental parameters (temperature for example) to which the piezoresistive detection elements 18 are subjected. The particular internal arrangement of the Wheatstone-bridge circuit 25 advantageously allows a differential measurement to be taken, in which changes in resistance due to the above-mentioned environmental parameters are cancelled, so that the output voltage Vₒᵤₜ, and thus the measured value of the pressure P, are rendered insensitive to these parameters.

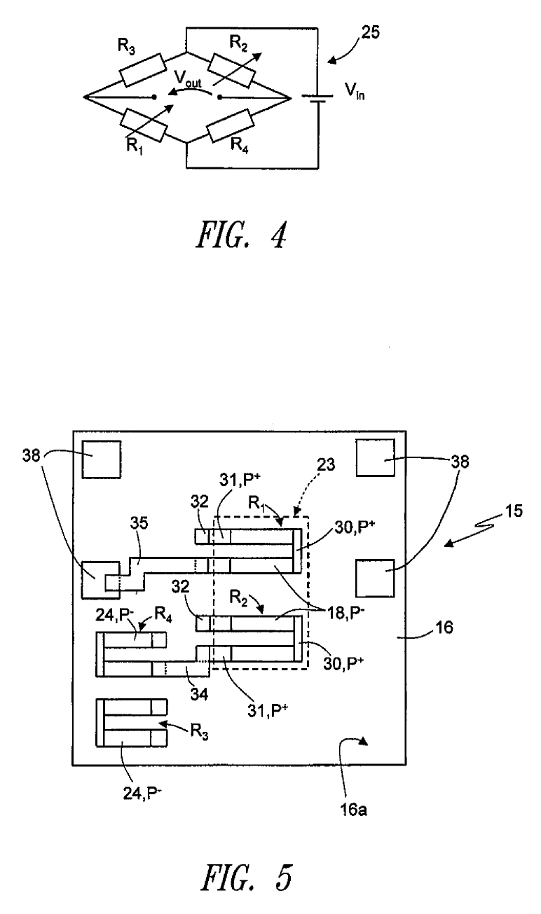

A possible embodiment of the pressure sensor 15 is schematically illustrated in FIG. 5.

In detail, four piezoresistive detection elements 18 are made inside the pressure-sensitive portion 23, and are connected two-by-two in series by first interconnections 30, constituted by P⁺-type diffused regions, so as to form a first and a second resistor (again indicated by R₁ and R₂). Second interconnections 31, these also constituted by P⁺-type diffused regions, connect the terminals of the first and of the second resistor R₁ and R₂ with the outside of the pressure-sensitive portion 23, where electrical contacts 32 are provided for contacting the second interconnections 31. Four reference elements 24, distinct and separate from the pressure-sensitive portion 23, are formed in the surface portion of the bulk region 17 and configured in a mirror-like fashion with respect to the piezoresistive detection elements 18, i.e., by also being connected two-by-two in series, so as to form a third and a fourth resistor (again indicated by R₃ and R₄).

The terminals of the third and fourth resistors R₃ and R₄ are opportunely connected via first metal lines 34, in aluminum for example, to the electrical contacts 32, in order to form the Wheatstone-bridge circuit 25 (FIG. 4), together with the first and second resistors R₁ and R₂. In FIG. 5, for sake of clarity, only one of the connections between the piezoresistive detection elements 18 and the reference elements 24 is shown, by way of example.

Second metal lines 35, also of aluminum for example, connect each of the electrical contacts 32 with respective pads 38 provided on the first main external surface 16a of the monolithic body 16 (again, by way of example, only one of the second metal lines 35 is shown). A connection can be made between the pads 38 and an electronic measurement circuit (not shown) integrating the reading electronics for the pressure sensor 15 using a known type wire-bonding technique, i.e., using electric wires. For example, the electronic measurement circuit could be positioned in a more protected environment than that of the braking system, for example, inside a control unit connected to the pressure sensor 15 via a shielded cable.

The described pressure sensor has a number of advantages.

First, it allows extremely high pressure values to be measured, with reduced costs and manufacturing complexity with respect to traditional pressure sensors. In particular, the pressure sensor, by not basing its operation on the deformation of a membrane (the monolithic body 16 does not in fact have either a membrane, or a cavity), but rather on the piezoresistive effects that occur in a solid and compact monolithic body of monocrystal silicon, can support and measure pressures with extremely high values. In fact, as is known, monocrystal silicon has a high break resistance to compression stress, having values that range from 11,200 Kg/cm² to 35,000 Kg/cm², according to the crystallographic orientation, for which it is fully capable of supporting the maximum pressure values (of around 1700 Kg/cm²) that occur inside a braking system. In a similar manner, the passivation layer 20 and the cushion layers 22a and 22b are able to support stresses of this order of magnitude.

The pressure sensor performs a differential type of measurement between one or more detection elements and one or more piezoresistive reference elements, and thus proves to be insensitive to variations in environmental parameters or manufacturing spread.

In addition, the presence inside the pressure-sensitive area 23 of P⁺-type diffused interconnections between the various piezoresistive detection elements 18 is advantageous. In fact, given the high values of pressure P, it is impossible to use normal connection techniques (aluminum metallization for example). These techniques can instead be used outside of the pressure-sensitive area 23, to create the connections between the detection elements and the reference elements.

Finally, it is clear that modifications and variations can be made to what described and illustrated herein without departing from the scope of protection of the present invention, as defined in the attached claims.

In particular, it is clear that the shape and dimensions of the monolithic body 16 can be different from that described and illustrated; in particular, the section of the monolithic body 16 could be rectangular or circular, instead of square.

Furthermore, the number of piezoresistive detection elements 18 and reference elements 24 could be different; even a single piezoresistive detection element 18 suitable for measuring the pressure P could be provided. Also the arrangement of the resistive elements inside the Wheatstone-bridge circuit 25 could be different from that illustrated.

The piezoresistive detection elements 18 could be formed with ion implantation techniques instead of diffusion.

In addition, in FIG. 6, an electronic measurement circuit 40, associated with the pressure sensor 15, could possibly be integrated inside the same monolithic body 16, in an area of the bulk region 17 separate from the pressure-sensitive portion 23, in order to form a pressure measurement device 41 integrated in a single chip. In particular, in FIG. 6, the electronic measurement circuit 40 is shown in an extremely simplified manner, by means of a single bipolar transistor 42. In a manner not shown, regions of electrical insulation could be provided for the electrical insulation of the electronic measurement circuit 40.

Finally, it is clear that the pressure sensor 15 could be also used to advantage in other applications that are different from the described braking system, wherein it is necessary to measure high pressure values.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A pressure sensor, comprising:
a monolithic body of semiconductor material having a first and a second main surface, opposite to each other and separated by a distance, said monolithic body also having a bulk region, with a sensitive portion, next to said first main surface, on which a pressure acts; and
a first piezoresistive detection element, integrated in said sensitive portion and having a variable resistance as a function of said pressure,
wherein said bulk region is a solid and compact region having a thickness substantially equal to said distance.

2. A pressure sensor according to claim 1, wherein said distance is substantially constant.

3. A pressure sensor according to claim 1, wherein said bulk region has a first type of conductivity; also comprising a second piezoresistive detection element integrated within said sensitive portion, said first and second piezoresistive detection elements comprising respective doped regions having a second type of conductivity, opposite to said first type of conductivity, and achieved by introducing dopants inside said sensitive portion.

4. A pressure sensor according to claim 3, further comprising interconnections that connect said first and second piezoresistive detection elements to each other, said interconnections comprising doped regions having said second type of conductivity, and formed by introducing dopants inside said sensitive portion.

5. A pressure sensor according to claim 1, wherein said sensitive portion is arranged in a central position with respect to said bulk region.

6. A pressure sensor according to claim 1, further comprising a piezoresistive reference element integrated in a portion of said bulk region separate and distinct with respect to said sensitive portion, said first piezoresistive reference element having a constant resistance as said pressure changes.

7. A pressure sensor according to claim 6, wherein said piezoresistive detection element and said first piezoresistive reference element are electrically connected to each other.

8. A pressure sensor according to claim 6, wherein said first piezoresistive detection element and said piezoresistive reference element are electrically connected to each other in a bridge circuit.

9. A pressure sensor according to claim 1, also comprising a cushion layer of elastic material, formed above said first main surface, and configured to distribute said pressure in a uniform manner on said sensitive portion.

10. A pressure measurement device, comprising:
a pressure sensor; and
a measurement circuit electrically coupled to said pressure sensor, wherein said pressure sensor includes:
a monolithic body of semiconductor material having a first and a second main surface, opposite to each other and separated by a distance, said monolithic body also having a bulk region, with a sensitive portion, next to said first main surface, on which a pressure acts; and
a first piezoresistive detection element, integrated in said sensitive portion and having a variable resistance as a function of said pressure,
wherein said bulk region is a solid and compact region having a thickness substantially equal to said distance.

11. A device according to claim 10, wherein said measurement circuit is integrated within said monolithic body.

12. A device according to claim 10, wherein said bulk region has a first type of conductivity; also comprising a second piezoresistive detection element integrated within said sensitive portion, said first and second piezoresistive detection elements comprising respective doped regions having a second type of conductivity, opposite to said first type of conductivity, and achieved by introducing dopants inside said sensitive portion.

13. A device according to claim 12, wherein the pressure sensor further includes interconnections that connect said first and second piezoresistive detection elements to each other, said interconnections comprising doped regions having said second type of conductivity, and formed by introducing dopants inside said sensitive portion.

14. A device according to claim 10, wherein the pressure sensor further includes a piezoresistive reference element integrated in a portion of said bulk region separate and distinct with respect to said sensitive portion, said first piezoresistive reference element having a constant resistance as said pressure changes.

15. A device according to claim 14, wherein said measurement circuit is structured to perform a pressure measurement as a function of a difference between resistances of said first piezoresistive detection element and said piezoresistive reference element.

16. A device according to claim 14, wherein said first piezoresistive detection element and said piezoresistive reference element are electrically connected to each other in a bridge circuit.

17. A device according to claim 10, also comprising a cushion layer of elastic material, formed above said first main surface, and configured to distribute said pressure in a uniform manner on said sensitive portion.

18. A braking system, comprising:
a brake; and
a pressure measurement device coupled to the brake, the pressure measurement device including:
a pressure sensor; and
a measurement circuit electrically coupled to said pressure sensor, wherein said pressure sensor includes:
a monolithic body of semiconductor material having a first and a second main surface, opposite to each other and separated by a distance, said monolithic body also having a bulk region, with a sensitive portion, next to said first main surface, on which a pressure acts; and
a first piezoresistive detection element, integrated in said sensitive portion and having a variable resistance as a function of said pressure,
wherein said bulk region is a solid and compact region having a thickness substantially equal to said distance.

19. A system according to claim 18, wherein the brake includes:
a brake disc;
an electronic control unit; and
an electromechanical actuator configured to exert a braking action on said brake disc in response to control signals generated by said electronic control unit, wherein said pressure measurement device is configured to take a measurement of a pressure exerted by said electromechanical actuator on said brake disc, is connected to said electronic control unit, and is structured to provide said electronic control unit with said measurement in feedback.

20. A system according to claim 18, wherein said measurement circuit is integrated within said monolithic body.

21. A system according to claim 18, wherein said bulk region has a first type of conductivity; also comprising a second piezoresistive detection element integrated within said sensitive portion, said first and second piezoresistive detection elements comprising respective doped regions having a second type of conductivity, opposite to said first type of conductivity, and achieved by introducing dopants inside said sensitive portion.

22. A system according to claim 21, wherein the pressure sensor further includes interconnections that connect said first and second piezoresistive detection elements to each other, said interconnections comprising doped regions having said second type of conductivity, and formed by introducing dopants inside said sensitive portion.

23. A system according to claim 18, wherein the pressure sensor further includes a piezoresistive reference element integrated in a portion of said bulk region separate and distinct with respect to said sensitive portion, said first piezoresistive reference element having a constant resistance as said pressure changes.

24. A system according to claim 23, wherein said measurement circuit is structured to perform a pressure measurement as a function of a difference between resistances of said first piezoresistive detection element and said piezoresistive reference element.

25. A system according to claim 23, wherein said first piezoresistive detection element and said piezoresistive reference element are electrically connected to each other in a bridge circuit.

26. A system according to claim 18, also comprising a cushion layer of elastic material, formed above said first main surface, and configured to distribute said pressure in a uniform manner on said sensitive portion.
